(19) United States
(12) Patent Application Publication
(10) Pub. No.: US 2022/0352576 A1
(43) Pub. Date: Nov. 3, 2022

(54) DEVICE FOR REGULATING THE TEMPERATURE OF AN ELECTRICAL ELEMENT BY MEANS OF A DIELECTRIC FLUID

(71) Applicant: Valeo Systemes Thermiques, Le Mesnil Saint-Denis (FR)

(72) Inventors: Kamel Azzouz, Le Mesnil Saint Denis Cedex (FR); Sébastien Garnier, Le Mesnil Saint Denis Cedex (FR); Amrid Mammeri, Le Mesnil Saint Denis Cedex (FR)

(73) Assignee: Valeo Systemes Thermiques, Le Mesnil Saint-Denis (FR)

(21) Appl. No.: 17/641,310

(22) PCT Filed: Sep. 8, 2020
(86) PCT No.: PCT/FR2020/051544

§ 371 Date: Mar. 8, 2022

(30) Foreign Application Priority Data
Sep. 10, 2019 (FR) 1909980

(51) Int. Cl. H01M 10/6568; H01M 10/613; H01M 10/6569

(52) U.S. Cl. CPC H01M 10/6568; H01M 10/613; H01M 10/6569; H01M 10/625

(57) ABSTRACT

Disclosed is a device (2) for regulating the temperature of an electrical element liable to heat up. The device (2) comprises a dielectric fluid circuit comprising sprinkling means (8) for sprinkling the surface of the element with the dielectric fluid and a tank (10) of dielectric fluid. The tank comprises a main volume (12). The main volume is intended to contain the electrical element liable to heat up, and a secondary volume (14) for storing dielectric fluid. The secondary volume is fluidically connected to the sprinkling means. The secondary volume is at least partially peripheral relative to the main volume.

The invention relates to a device for regulating the temperature of an electric battery or another electric element to be cooled and/or heated using a dielectric fluid, and to the electric battery comprising said device. It is in particular intended to equip motor vehicles, in particular motor vehicles with an electric or hybrid drive.

As the market share represented by electric vehicles continues to grow, the problems of cooling/heating the battery packs with which they are equipped are taking on strategic importance. The objective is to design the best-performing, most efficient and economical battery thermal management device possible.

To meet the need for cooling/heating electric batteries, use is often made of “heat exchangers” consisting of a cold plate with circulation of a coolant liquid, the plates being in contact with the cells to be cooled. This kind of technique can lead to non-uniform cooling of the batteries and thus limits battery life and performance. These devices also exhibit relatively high thermal resistance because of the material thicknesses present between the coolant liquid and the cells.

One proposed solution for addressing these problems consists in immersing the cells forming the electric batteries in a dielectric heat-transfer fluid. This immersion can be achieved with a circulation of fluid or under static conditions involving a phase change.

These two techniques perform well from a thermal standpoint, particularly on account of the direct contact established between the liquid and the cells, but have the disadvantage of using a large quantity of dielectric liquid, thereby increasing the cost and weight of the battery pack. To overcome this drawback, dielectric-fluid circuits for sprinkling the cells with dielectric fluid are known. However, an inclination of the vehicle can prevent the dielectric fluid from being conveyed correctly toward the dielectric-fluid pump.

The invention aims to solve these problems by proposing a device for regulating the temperature of an electric element that is able to heat up, said device comprising a dielectric-fluid circuit, said circuit comprising sprinkling means for sprinkling the surface of said element using said dielectric fluid, and a dielectric-fluid reservoir, characterized in that the reservoir comprises a main volume, said main volume being intended for containing said electric element that is able to heat up, and an ancillary volume for storing dielectric fluid, said ancillary volume being fluidically connected to said sprinkling means, said ancillary volume being at least partially peripheral with respect to the main volume.

The device may also comprise any one of the following features, considered individually or in any technically possible combination:
said ancillary volume is at least partially around the main volume;
said ancillary volume comprises a dielectric-fluid outlet orifice fluidically connected to said pump;
said ancillary volume is configured such that, in any position in which the device is inclined by 15° with respect to the horizontal, a dielectric-fluid outlet orifice of the ancillary volume is immersed if the ancillary volume is filled with dielectric fluid;
the main volume (12) is delimited by a first enclosure;
the ancillary volume (14) is delimited by a second enclosure, which is separate from the first enclosure;
the second enclosure is at least partially around the first enclosure;
the first enclosure is formed by a first peripheral wall and the second enclosure is formed by a second wall extending at least in part around the first wall;
the first wall and the second wall together delimit said ancillary volume;
the device comprises a pump for pumping the dielectric fluid from the ancillary volume toward said sprinkling means;
said device comprises at least one solenoid valve for opening/closing the fluidic connection between said ancillary volume and said pump;
said device comprises a raising pump for feeding the dielectric fluid from said main volume toward said ancillary volume;
the sprinkling means comprise sprinkler nozzles;
the sprinkler nozzles are defined by sprinkler orifices;
said electric element is an energy storage cell;
said cells comprise a body, the electrical coupling connectors being located on an upper face of the body;
said battery comprises a condensation plate, which is located facing said upper face of the cells;
the device comprises means for regulating the temperature of the condensation plate;
the condensation plate defines a circuit for the passage of a heat-transfer liquid in the condensation plate.

Another subject of the invention is an electric battery comprising a sealed closed body, said body comprising said electric element that is able to heat up and a device as described above for regulating the temperature of said electric element.

The battery may also comprise any one of the following features, considered individually or in any technically possible combination:
the battery comprises multiple modules, each comprising multiple energy storage cells;
the battery comprises one thermal regulation device per module, in particular one pump per module;
the battery comprises a common device and a common pump for multiple modules, for example for all of the modules, each module comprising a dielectric-fluid reservoir as described above.

Another subject of the invention is an electrical system comprising said battery, means for measuring the inclination of said device, and a controller.

The electrical system may also comprise any one of the following features, considered individually or in any technically possible combination:
the device comprises a solenoid valve for opening/closing the fluidic connection between said ancillary volume and said pump, and a controller for controlling the solenoid valve on the basis of an inclination measurement;
the device comprises an additional pump having the same features as said pump for pumping the dielectric fluid toward the sprinkling means, the two pumps being provided with non-return valves;
the controller controls one or the other of the pumps on the basis of an inclination measurement.

The invention will be better understood and further details, features and advantages of the invention will become apparent from reading the following description given by way of non-limiting example and with reference to the appended drawings, in which:

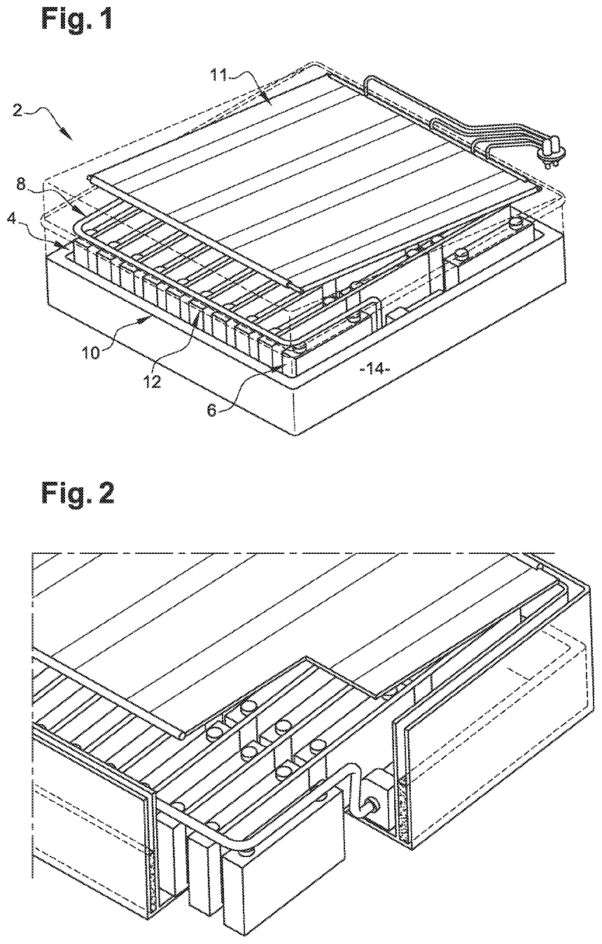

FIG. 1 shows a perspective illustration of a device for thermally regulating a battery according to one embodiment of the invention, in a horizontal position;

FIG. 2 partial and enlarged of FIG. 1;

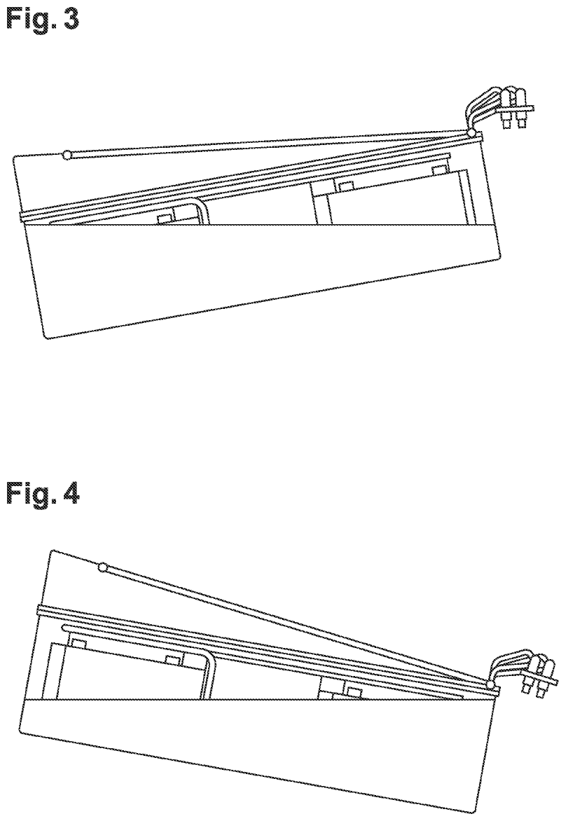

FIG. 3 is a schematic view in section of FIG. 1, in an inclined position;

FIG. 4 is a view similar to FIG. 3, inclined in the opposite direction.

FIG. 1 illustrates a device 2 for regulating the temperature of a battery 4 comprising multiple energy storage cells 6. As a variant, however, it involves any other electric element to be cooled.

The device comprises a dielectric-fluid circuit for cooling or heating the cells 6.

The circuit comprises sprinkling means 8 for sprinkling the surface of the cells 6 using said dielectric fluid, a dielectric-fluid reservoir 10, and a pump (not shown) for pumping the dielectric fluid toward said sprinkling means 8.

The dielectric fluid is sprinkled in the liquid phase or in a bi-phasic mixture. The evaporation of the dielectric from the surface of the cells cools the cells and evaporates the dielectric fluid. To save on dielectric fluid, the volume of dielectric fluid in the reservoir is at most 20% of the volume of the reservoir, preferably at most 10%.

The dielectric fluid is cooled and thus condensed by a condenser 11 in the form of a plate disposed above the cells 6. The plate delimits within it a refrigerant circuit connected by pipes to an external refrigerant circuit, but as a variant it is of any type suitable for cooling the dielectric fluid and thus condensing it for its recovery in the reservoir 10.

The reservoir 10 comprises a main volume 12 intended for containing the energy storage cells 6, and an ancillary volume 14 for storing dielectric fluid.

The main volume 12 is delimited by a first enclosure, which is formed by a first peripheral wall. The ancillary volume 14 is delimited by a second enclosure, around the first enclosure, between the first wall and a second wall extending around the first wall.

The ancillary volume thus extends peripherally around the main volume.

The height of the ancillary volume extends over the entire height of the main volume at least. It is thus at least in part at the same horizontal level.

By contrast, the ancillary volume has a dimension much smaller than that of the main volume, specifically its width, in this instance measured between the first wall and the second wall, and compared to the width of the main volume between two facing sides of the first wall.

In general, the ancillary volume has a dimension in a horizontal plane that is smaller than the same dimension of the main volume.

By virtue of its reduced dimensions, even in the event of inclination of the vehicle, the ancillary volume keeps within them a sufficient quantity of dielectric fluid to supply the pump for a period of time.

Furthermore, its peripheral disposition ensures that at least part of the ancillary volume supplies dielectric fluid in the event of constant inclination, for example. The orifices of the ancillary volumes are provided, for example, with a non-return valve to avoid the ducts supplying the pump emptying under the effect of the inclination of the device. The pump remains permanently supplied, even over a long inclination duration.

To this end, in general, at least one ancillary dimension of an ancillary volume is at most equal to ½ of the same dimension of the main volume, preferably at most equal to ⅓.

The ancillary volumes are thus configured such that, in any position in which the device is inclined by 15° with respect to the horizontal, the dielectric-fluid outlet orifice is immersed. In this instance, the ancillary volume 14 has a parallelepipedal shape but as a variant it is of any suitable type.

The pump is for example connected directly to the volume 14, without intermediate ducts. To that end, the pump has an inlet orifice in contact with an outlet orifice of the ancillary volume, but as a variant this fluidic connection between the two is of any suitable type.

As a variant, a raising pump is connected to a low point of the main volume 12. This variant thus makes it possible to recover the dielectric fluid in this other part of the main volume and conveys the dielectric fluid toward the ancillary volume 14.

In all of the embodiments, solenoid valves, coupled to an inclination-detecting means, are provided, for example. It is thus possible to close the ducts that are not supplied with fluid.

Likewise in all of the embodiments, the battery may comprise multiple modules, each comprising multiple energy storage cells.

Two solutions are envisioned:
the battery comprises one thermal regulation device per module, in particular one pump per module;
the battery comprises a common device and a common pump for multiple modules, for example for all of the modules, each module comprising a dielectric-fluid reservoir as described above.

1. A device for regulating the temperature of an electric element that is able to heat up, said device comprising:
a dielectric-fluid circuit comprising sprinkling means for sprinkling the surface of said element using said dielectric fluid; and
a dielectric-fluid reservoir comprising a main volume, said main volume containing said electric element that is able to heat up, and an ancillary volume for storing dielectric fluid, said ancillary volume being fluidically connected to said sprinkling means and at least partially peripheral with respect to the main volume.

2. The device as claimed in claim 1, wherein said ancillary volume is at least partially around the main volume.

3. The device as claimed in claim 1, wherein said ancillary volume is configured such that, in any position in which the device is inclined by 15° with respect to the horizontal, a dielectric-fluid outlet orifice of the ancillary volume is immersed if the ancillary volume is filled with dielectric fluid.

4. The device as claimed in claim 1, wherein the main volume is delimited by a first enclosure.

5. The device as claimed in claim 1, wherein the ancillary volume is delimited by a second enclosure, which is separate from the first enclosure.

6. The device as claimed in claim 5, wherein the second enclosure is at least partially around the first enclosure.

7. The device as claimed in claim 6, wherein the first enclosure is formed by a first peripheral wall and the second enclosure is formed by a second wall extending at least in part around the first wall.

8. The device as claimed in claim 7, wherein the first wall and the second wall together delimit said ancillary volume.

9. The device as claimed in claim 1, comprising a pump for pumping the dielectric fluid from the ancillary volume toward said sprinkling means.

10. An electric battery comprising: a sealed closed body, said body comprising said electric element that is able to heat up; and a device as claimed in claim 1 for regulating the temperature of said electric element.

11. An electrical system comprising: the battery as claimed in claim 10; means for measuring the inclination of said device; and a controller.
